(19) United States
(12) Patent Application Publication
(10) Pub. No.: US 2014/0196866 A1
(43) Pub. Date: Jul. 17, 2014

(54) RETURN AIR DUCTS FOR VEHICLES

(71) Applicant: GM GLOBAL TECHNOLOGY OPERATIONS LLC, Detroit, MI (US)

(72) Inventors: Charles A. Bezzina, Livonia, MI (US); Michael G. Leffert, Howell, MI (US); Rolf B. Karlsson, Grand Blanc, MI (US)

(73) Assignee: GM GLOBAL TECHNOLOGY OPERATIONS LLC, Detroit, MI (US)

(21) Appl. No.: 13/742,726

(22) Filed: Jan. 16, 2013

(51) Int. Cl. B60H 1/00

(52) U.S. Cl. CPC B60H 1/00278; B60H 1/00028
USPC 165/42

(57) ABSTRACT

A vehicle includes an air inlet passage, a cargo compartment, a passenger compartment, a battery, and a heating, ventilation, and air conditioning (HVAC) unit. The battery is disposed in the cargo compartment. The HVAC unit is disposed between the engine and passenger compartments. The HVAC unit includes a first inlet, a second inlet, a third inlet, and an outlet all in fluid communication with one another. A recirculation door moves between a pass-through position and a recirculation position. A return air duct extends between the cargo compartment and the second inlet. The return air duct directs the flow of the heated air from the cargo compartment directly to the second inlet of the HVAC unit when the recirculation door is in the recirculation position.

### TECHNICAL FIELD

The present disclosure generally relates to return air ducts for vehicles.

### BACKGROUND

Ambient or conditioned air may be channeled from one area of a vehicle to another via a return air duct. For example, the return air duct may channel heated, cooled, and/or humidified air from one portion of the vehicle, such as an instrument panel, to another portion of the vehicle, such as a rear passenger footwell. Often, a path or routing for the return air duct through the vehicle is circuitous, because of obstacles such as seating hardware, electronics, structural components, and the like.

### SUMMARY

A vehicle includes an air inlet passage, a cargo compartment, a passenger compartment, a battery, and a heating, ventilation, and air conditioning (HVAC) unit. The passenger compartment is disposed between the air inlet passage and the cargo compartment. The battery is operably disposed inside the vehicle and dissipates heat when energized such that air in the cargo compartment becomes heated air. The HVAC unit is operably disposed between the air inlet passage and the passenger compartment. The HVAC unit includes a first inlet, a second inlet, a third inlet, and an outlet all in fluid communication with one another. A recirculation door is configured for moving between a pass-through position and a recirculation position. A return air duct operably extends between the cargo compartment and the second inlet. The return air duct is configured to direct the flow of the heated air from the cargo compartment directly to the HVAC unit. The HVAC unit is configured to intake air through the first inlet and exhaust air through the outlet to the passenger compartment when the recirculation door is in the pass-through position. The HVAC unit is configured to intake air through the second inlet and the third inlet and exhaust through the outlet to the passenger compartment when the recirculation door is in the recirculation position.

In another aspect of the disclosure, a vehicle includes an air inlet passage, a cargo compartment, a passenger compartment, and a heating, ventilation, and air conditioning (HVAC) unit. The cargo compartment is configured for holding a battery which heats surrounding air when energized such that air in the cargo compartment becomes heated air. The passenger compartment is disposed between the air inlet passage and the cargo compartment. The HVAC unit is operably disposed between the air inlet passage and the passenger compartment. The HVAC unit includes a first inlet, a second inlet, and an outlet all in fluid communication with one another. A recirculation door is configured for moving between a pass-through position and a recirculation position. A return air duct operably extends between the cargo compartment and the second inlet and is configured to direct the flow of the heated air from the cargo compartment directly to the HVAC unit. The HVAC unit is configured to intake air through the first inlet and exhaust air through the outlet to the passenger compartment when the recirculation door is in the pass-through position. The HVAC unit is configured to intake air through the second inlet and exhaust through the outlet to the passenger compartment when the recirculation door is in the recirculation position.

In yet another aspect of the disclosure, a method of cooling a battery in a cargo compartment of a vehicle is provided. The method includes operating an HVAC unit with a recirculation door in a recirculation position. Air is exhausted from an outlet of the HVAC unit into a passenger compartment. Air is drawn from the passenger compartment into the cargo compartment. Air is heated within the cargo compartment and the heated air is exhausted from the cargo compartment to the HVAC unit through a return air duct such that the heated air is cooled by the HVAC unit.

The detailed description and the drawings or Figures are supportive and descriptive of the disclosure, but the scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic side view of a vehicle having an HVAC unit having a recirculation door in a pass-through position; and

FIG. 2 is a schematic side view of the vehicle having the HVAC unit with the recirculation door in a recirculation position.

### DETAILED DESCRIPTION

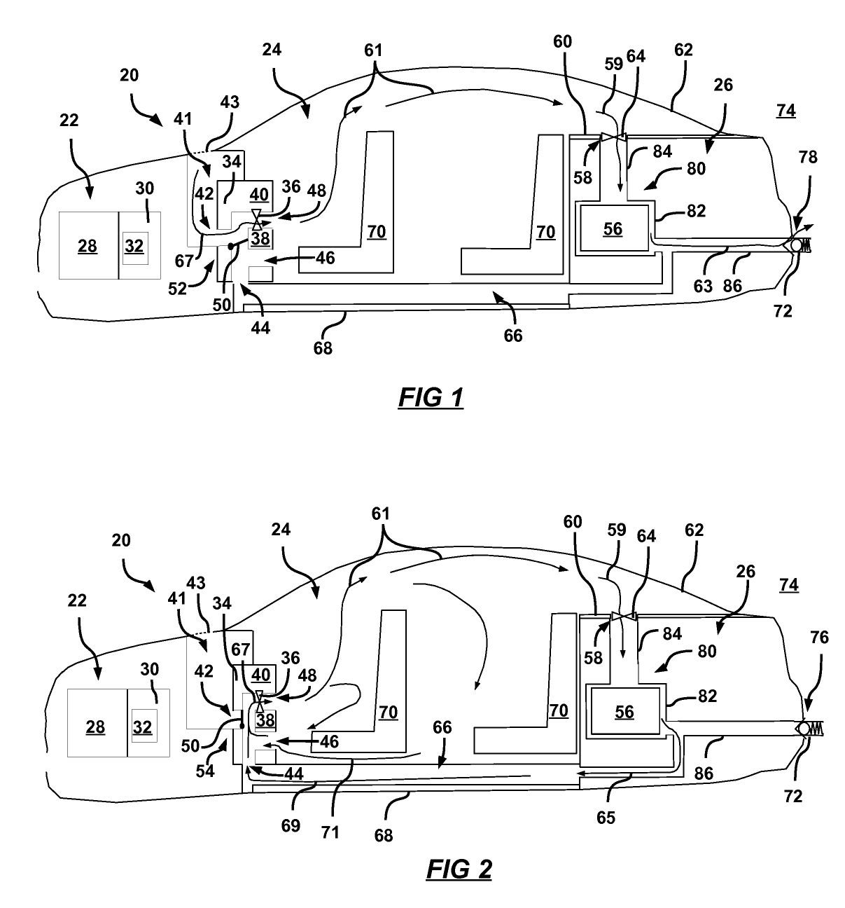

Referring to the Figures, wherein like reference numerals refer to like elements, a vehicle 20 is shown in FIGS. 1 and 2. The vehicle 20 includes an engine compartment 22, a passenger compartment 24, and a cargo compartment 26. The passenger compartment 24 is disposed between the engine compartment 22 and the cargo compartment 26.

The vehicle 20 may be a hybrid electric vehicle (HEV) that includes a powertrain having an internal combustion engine 28 and a transmission 30 which are configured to cooperatively propel the vehicle 20. In addition to the engine 28 and the transmission 30, the vehicle 20 may be configured to be propelled by a motor/generator 32, alone or in combination with the engine 28. As shown, the motor/generator 32 is positioned within the transmission 30, but may also be positioned anywhere in the vehicle 20, depending on the vehicle 20 architecture and control of the power flow, as known by those skilled in the art. Although a single motor/generator 32 is shown, depending on the actual configuration of the vehicle 20, there may be multiple motor/generators 32 within the driveline of a subject vehicle 20.

A heating, ventilation, and air conditioning (HVAC) unit 34 is operably disposed between the engine compartment 22 and the passenger compartment 24. The HVAC unit 34 may include a blower 36, an evaporator 38, and a heater core 40. The blower 36 is configured for selectively moving air throughout the HVAC unit 34. The evaporator 38 is configured for cooling air within the HVAC unit 34. Likewise, the heater core 40 is configured for heating air within the HVAC unit 34. The HVAC unit 34 includes a first inlet 42, a second inlet 44, a third inlet 46, and an outlet 48, all in fluid communication with one another inside of the HVAC unit 34. An air inlet passage 41 is disposed between the first inlet 42 and an outside 74 of the vehicle, e.g., through a plenum 43 and the like. The air inlet passage 41 is disposed near the engine compartment 22, where the first inlet 42 is in communication with the air inlet passage 41 to receive air from outside of the vehicle, as illustrated by arrow 67 in FIG. 1.

The HVAC unit 34 also includes a recirculation door 50 which is configured for moving between a pass-through position 52, shown in FIG. 1, and a recirculation position 54, shown in FIG. 2. The HVAC unit 34 is configured to intake air through the first inlet 42 and exhaust air through the outlet 48 to the passenger compartment 24 when the recirculation door 50 is in the pass-through position 52. Likewise, when the recirculation door 50 is in the recirculation position 54, the HVAC unit 34 intakes air through the second and third inlets 44, 46 and exhausts air through the outlet 48 to the passenger compartment 24.

A battery 56 is operably disposed inside of the vehicle 10. As shown in FIGS. 1 and 2, the battery 56 is operably disposed in the cargo compartment 26. The cargo compartment 26 is the location within the vehicle that is generally disposed behind rear-most seats 70 of the vehicle 10, e.g., a trunk compartment. However, it should be appreciated that the battery 56 may be disposed anywhere inside of the vehicle 10, such as the passenger compartment 24, the engine compartment 22, and the like. By way of a non-limiting example, the battery 56 may be disposed beneath one or more seats 70 of the vehicle. The battery 56 may be a high voltage (HV) battery 56 in the HEV application of the vehicle 20. The battery 56 is configured to be energized to provide power to the powertrain to operate, or otherwise propel, the vehicle 20. When the battery 56 is energizing the motor/generator 32, the battery 56 dissipates heat. As a result of the heat dissipated by energizing the battery 56, air inside of the cargo compartment 26 becomes heated air. When the battery 56 is above ambient temperature, the battery 56 will lose heat through conduction, convection, and radiation. If the ambient temperature becomes greater than the temperature of the battery 56, the battery 56 will absorb heat from the surroundings. Keeping the temperature of the battery 56 low will promote an increased life of the battery 56, which could improve a manufacturing warranty and resale value of the vehicle 20. Therefore, the battery 56 is configured to be air cooled.

A cargo inlet 58 is defined between the passenger compartment 24 and the cargo compartment 26. The cargo inlet 58 may be defined in a shelf 60, proximate a rear window 62 of the vehicle 20. It should be appreciated that other locations disposed between the passenger compartment 24 and the cargo compartment 26 may also be used. A fan 64 may be operably disposed in the cargo inlet 58, between the passenger compartment 24 and the cargo compartment 26, to draw air into the cargo compartment 26, from the passenger compartment 24, to cool the battery 56. Operation of the fan 64 provides a negative pressure differential between the passenger compartment 24 and the cargo compartment 26 such that that fan 64 draws air from the passenger compartment 24 into the cargo compartment 26. Therefore, the battery 56 may be air cooled by directing cooler air from the passenger compartment 24 into the cargo compartment 26, as indicated by the arrow 59. More specifically, cooler air is air that is at a temperature which is less than a temperature of the heated air that is inside of the cargo compartment 26.

A return air duct 66 operably extends between the cargo compartment 26 and the second inlet 44 of the HVAC unit 34. The return air duct 66 may be disposed proximate a bottom 68 of the vehicle 20. By way of a non-limiting example, the return air duct 66 may extend beneath seats 70 of the vehicle 20, between the cargo compartment 26 and the second inlet 44 of the HVAC unit 34. The return air duct 66 is configured to direct the flow of air from the cargo compartment 26 directly to the HVAC unit 34, as will be explained in more detail below. Therefore, the return air duct 66 only passes between the cargo compartment 26 and the HVAC unit 34 and does not provide any air flow directly to the passenger compartment 24.

During vehicle 20 operation, the blower 36 of the HVAC unit 34 and the fan 64 facilitate the continuous circulation of air between the passenger compartment 24 and the cargo compartment 26. In order to facilitate the continuous circulation of air, the first inlet 42 is in fluid communication with the outside 74 of the vehicle 10, via the air inlet passage, the second inlet 44 is in fluid communication with the return air duct 66, the third inlet 46 is in fluid communication with the passenger compartment 24, and the outlet 48 is in fluid communication with the passenger compartment 24. As the vehicle 20 operates, air flows from the HVAC unit 34 into the passenger compartment 24 through the outlet 48, as illustrated by arrow 67, and air flows from the passenger compartment 24 to the cargo compartment 26, as indicated by arrow 59. Air within the passenger compartment 24, as illustrated by arrow 61, is continuously drawn into the cargo compartment 26 through the cargo inlet 58 and the heated air is continuously vented from the cargo compartment 26, as illustrated by arrow 63. The heated air is vented from the cargo compartment 26 in one of two ways, which are dependent on the position of the recirculation door 50. The heated air is either vented through a pressure relief valve 72, as illustrated by arrow 63 in FIG. 1, when the recirculation door 50 is in the pass-through position 52, or through the return air duct 66, as illustrated by arrow 65 in FIG. 2, when the recirculation door 50 is in the recirculation position 54, illustrated in FIG. 2.

The pressure relief valve 72 is operably disposed between the cargo compartment 26 and an outside 74 of the vehicle 20. The pressure relief valve 72 is configured to move between a closed position 76, shown in FIG. 2, and an open position 78, shown in FIG. 1. Air is configured to flow from the cargo compartment 26 to the outside 74 of the vehicle 20 through the pressure relief valve 72 when the pressure relief valve 72 is in the open position 78 and the recirculation door 50 is in the pass-through position 52, as shown in FIG. 1. The pressure relief valve 72 is operable for actuating or opening in response to a low differential pressure between the cargo compartment 26 and the outside 74 of the vehicle 20. More specifically, when the recirculation door 50 is in the pass-through position 52, air flows into the HVAC unit 34 through the first inlet 42 and into the passenger compartment 24 of the vehicle 20 through the outlet 48. The air enters the cargo compartment 26 at a pressure which is greater than the pressure outside 74 of the vehicle 20. This differential pressure is great enough to bias the pressure relief valve 72 into the open position 78, allowing the heated air to exit the cargo compartment 26. Therefore, the pressure relief valve 72 is normally biased into the closed position 76 and is configured to automatically move to the open position 78 in response to a positive pressure differential between the cargo compartment 26 and the outside 74 of the vehicle 20 when the recirculation door 50 is in the pass-through position 52.

Likewise, the pressure relief valve 72 is configured to automatically move to the closed position 76 in response to a negative pressure differential between the cargo compartment 26 and the outside 74 of the vehicle 20 when the recirculation door 50 is in the recirculation position 54. More specifically, when the recirculation door 50 is in the recirculation position 54, air flows into the HVAC unit 34 only through the second inlet 44, as illustrated by arrow 69, and third inlet 46, as illustrated by arrow 71, by virtue of the recirculation door 50 preventing air from entering the HVAC unit 34 through the first inlet 42. As the air is moved through the HVAC unit 34 with the recirculation door 50 in the recirculation position 54, a negative pressure differential is created between the cargo compartment 26 and the outside 74 of the vehicle 20, causing the pressure relief valve 72 to be in the closed position 76. As such, operation of the blower 36 of the HVAC unit 34 creates suction at the second inlet 44 and the third inlet 46. As a result, air flows from the cargo compartment 26 through the return air duct 66 to the second inlet 44 and air flows from the passenger compartment 24 to the third inlet 46, as shown in FIG. 2.

The movement of the heated air through the return air duct 66 to the first inlet 42 means that the heated air becomes cooled by the evaporator 38 within the HVAC unit 34 upon entering the first inlet 42. As such, cooled air continuously flows from the outlet 48 into the passenger compartment 24 when the recirculation door 50 is in the recirculation position 54. Without the return air duct 66 connecting the cargo compartment 26 to the second inlet 44, where the negative pressure differential between the cargo compartment 26 and the outside 74 keeps the pressure relief valve 72 in the closed position 76, the heated air would otherwise seep, or escape from the cargo compartment 26, directly into the passenger compartment 24. This would cause the air within the passenger compartment 24 to become heated, which would cause the air entering the cargo compartment 26 to eventually become heated air, in addition to the rear of the passenger compartment 24 becoming warmer than desired for optimal passenger comfort.

Additionally, a cooling assembly 80 may be disposed within the cargo compartment 26 to provide air cooling to the battery 56. The cooling assembly 80 may include a cooling housing 82, an inlet duct 84, and an exhaust duct 86. The battery 56 is operatively disposed inside of the cooling housing 82 such that air flows around or throughout the battery 56, between the inlet duct 84 and exhaust duct 86. The inlet duct 84 is operatively connected between the cargo inlet 58 and the cooling housing 82. The exhaust duct 86 is operatively connected between the cooling housing 82 and each of the pressure relief valve 72 and the return air duct 66. Therefore, with reference to FIG. 1, when the recirculation door 50 is in the pass through position 52, the resulting negative pressure differential draws the heated air from the cooling housing 82, through the exhaust duct 86, and to the outside 74 of the vehicle 20 through the pressure relief valve 72, as indicated by arrow 63. Likewise, with reference to FIG. 2, when the recirculation door 50 is in the recirculation position 54, the positive pressure differential draws the heated air from the cooling housing, through the exhaust duct 86, and into the return air duct 66, as indicated by arrow 65.

While the best modes for carrying out the disclosure have been described in detail, those familiar with the art to which this disclosure relates will recognize various alternative designs and embodiments for practicing the disclosure within the scope of the appended claims.

1. A vehicle comprising:
an air inlet passage in fluid communication with an outside of the vehicle;
a cargo compartment;
a passenger compartment disposed between the air inlet passage and the cargo compartment;
a battery which dissipates heat when energized such that air in the vehicle becomes heated air;
a heating, ventilation, and air conditioning (HVAC) unit operably disposed between the air inlet passage and the passenger compartment;
wherein the HVAC unit includes:
a first inlet, a second inlet, a third inlet, and an outlet all in fluid communication with one another; and
a recirculation door configured for moving between a pass-through position and a recirculation position; and
a return air duct operably extending between the cargo compartment and the second inlet and configured to direct the flow of the heated air from the cargo compartment directly to the HVAC unit;
wherein the HVAC unit is configured to intake air through the first inlet and exhaust air through the outlet to the passenger compartment when the recirculation door is in the pass-through position; and
wherein the HVAC unit is configured to intake air through the second inlet and the third inlet and exhaust air through the outlet to the passenger compartment when the recirculation door is in the recirculation position.

2. The vehicle, as set forth in claim 1, wherein the first inlet is in fluid communication with the air inlet passage; and
wherein the third inlet is in fluid communication with the passenger compartment.

3. The vehicle, as set forth in claim 2, further comprising a pressure relief valve operably disposed between the cargo compartment and an outside of the vehicle;
wherein the pressure relief valve is configured to move between an open position and a closed position;
wherein air is configured to flow from the cargo compartment to the outside of the vehicle through the pressure relief valve when the pressure relief valve is in the open position and the recirculation door is in the pass-through position; and
wherein air is configured to flow from the cargo compartment through the return air duct to the second inlet when the pressure relief valve is in the closed position and the recirculation door is in the recirculation position.

4. The vehicle, as set forth in claim 3, wherein the pressure relief valve is configured to automatically move to the open position in response to a positive pressure differential between the cargo compartment and the outside of the vehicle when the recirculation door is in the pass-through position; and
wherein the pressure relief valve is configured to automatically move to the closed position in response to a negative pressure differential between the cargo compartment and the outside of the vehicle when the recirculation door is in the recirculation position.

5. The vehicle, as set forth in claim 1, further comprising a fan operatively disposed between the passenger compartment and the cargo compartment;
wherein fan is configured to draw air from the passenger compartment into the cargo compartment.

6. The vehicle, as set forth in claim 5, further comprising a shelf disposed between the passenger compartment and the cargo compartment;
wherein the shelf defines a cargo inlet opening between the passenger compartment and the cargo compartment; and
wherein the fan is operatively disposed within the cargo inlet.

7. The vehicle, as set forth in claim 6, wherein the battery is further defined as being disposed in the cargo compartment.

8. The vehicle, as set forth in claim 7, further comprising a cooling assembly disposed in the cargo compartment, the cooling assembly including an inlet duct, a cooling housing, and an exhaust duct;
wherein the inlet duct is operatively connected between the cargo inlet and the cooling housing such that air flows through the inlet duct from the cargo inlet to the cooling housing;
wherein the battery is operably disposed inside the cooling housing such that air flows past the battery within the cooling housing between the inlet duct and the exhaust duct; and
wherein the exhaust duct is operatively connected between the cooling housing and the return air duct such that air flows through the exhaust duct from the cooling housing to the return air duct.

9. A vehicle comprising:
an air inlet passage in fluid communication with an outside of the vehicle;
a cargo compartment configured for holding a battery which heats surrounding air when energized such that air in the cargo compartment becomes heated air;
a passenger compartment disposed between the air inlet passage and the cargo compartment;
a heating, ventilation, and air conditioning (HVAC) unit operably disposed between the air inlet passage and the passenger compartment;
wherein the HVAC unit includes:
a first inlet, a second inlet, and an outlet all in fluid communication with one another; and
a recirculation door configured for moving between a pass-through position and a recirculation position; and
a return air duct operably extending between the cargo compartment and the second inlet and configured to direct the flow of the heated air from the cargo compartment directly to the HVAC unit;
wherein the HVAC unit is configured to intake air through the first inlet and exhaust air through the outlet to the passenger compartment when the recirculation door is in the pass-through position; and
wherein the HVAC unit is configured to intake air through the second inlet and exhaust air through the outlet to the passenger compartment when the recirculation door is in the recirculation position.

10. The vehicle, as set forth in claim 8, wherein the first inlet is in fluid communication with the air inlet passage.

11. The vehicle, as set forth in claim 9, wherein the HVAC unit further includes a third inlet; and
wherein the HVAC unit is configured to intake air from the second inlet and the third inlet and exhaust through the outlet to the passenger compartment when the recirculation door is in the recirculation position.

12. The vehicle, as set forth in claim 9, further comprising a pressure relief valve operably disposed between the cargo compartment and an outside of the vehicle;
wherein the pressure relief valve is configured to move between an open position and a closed position;
wherein air is configured to flow from the cargo compartment to the outside of the vehicle through the pressure relief valve when the pressure relief valve is in the open position and the recirculation door is in the pass-through position; and
wherein air is configured to flow from the cargo compartment through the return air duct to the second inlet when the pressure relief valve is in the closed position and the recirculation door is in the recirculation position.

13. The vehicle, as set forth in claim 11, wherein the pressure relief valve is configured to automatically move to the open position in response to a positive pressure differential between the cargo compartment and the outside of the vehicle when the recirculation door is in the pass-through position; and
wherein the pressure relief valve is configured to automatically move to the closed position in response to a negative pressure differential between the cargo compartment and the outside of the vehicle when the recirculation door is in the recirculation position.

14. The vehicle, as set forth in claim 12, further comprising a fan operatively disposed between the passenger compartment and the cargo compartment;
wherein the fan is configured to draw air from the passenger compartment into the cargo compartment.

15. The vehicle, as set forth in claim 12, further comprising a shelf disposed between the passenger compartment and the cargo compartment;
wherein the shelf defines a cargo inlet opening between the passenger compartment and the cargo compartment; and
wherein the fan is operatively disposed within the cargo inlet.

16. The vehicle, as set forth in claim 15, wherein the battery is further defined as being disposed in the cargo compartment.

17. The vehicle, as set forth in claim 16, further comprising a cooling assembly disposed in the cargo compartment, the cooling assembly including an inlet duct, a cooling housing, and an exhaust duct;
wherein the inlet duct is operatively connected between the cargo inlet and the cooling housing such that air flows through the inlet duct from the cargo inlet to the cooling housing;
wherein the battery is operably disposed inside the cooling housing such that air flows past the battery within the cooling housing between the inlet duct and the exhaust duct; and
wherein the exhaust duct is operatively connected between the cooling housing and the return air duct such that air flows through the exhaust duct from the cooling housing to the return air duct.

18. A method of cooling a battery in a cargo compartment of a vehicle, the method comprising:
operating a heating, ventilation, and air conditioning (HVAC) unit with a recirculation door in a recirculation position;
exhausting air from an outlet of the HVAC unit into a passenger compartment;
drawing air from the passenger compartment into the cargo compartment;
heating air within the cargo compartment; and
exhausting heated air from the cargo compartment to the HVAC unit through a return air duct such that the heated air is cooled by the HVAC unit.

19. A method, as set forth in claim 16, further comprising operating a fan between the passenger compartment and the cargo compartment such that air is drawn from the passenger compartment to the cargo compartment.

20. A method, as set forth in claim 16, further comprising moving a pressure relief device disposed between the cargo compartment and an outside of the vehicle from an open position to a closed position in response to operating the HVAC unit with the recirculation door in the recirculation position such that the heated air is prevented from exiting the cargo compartment through the pressure relief valve.
